(19) United States
(12) Patent Application Publication
(10) Pub. No.: US 2006/0019665 A1
(43) Pub. Date: Jan. 26, 2006

(54) Cellular communications systems

(76) Inventors: Abdol Hamid Aghvami, London (GB); Fatin Said, London (GB); Seyed Ali Ghorashi, London (GB); Lin Wang, Sutton (GB)

Correspondence Address: KELLEY DRYE & WARREN LLP;TWO STAMFORD PLAZA, 281 TRESSER BOULEVARD, STAMFORD, CT, 06901-3229, US

(21) Appl. No.: 10/521,536

(22) PCT Filed: Jan. 22, 2004
(86) PCT No.: PCT/GB03/03070

§ 371 Date: Jul. 19, 2005

(30) Foreign Application Priority Data
Jul. 15, 2002 (GB) 0216291.5

(51) Int. Cl. H04Q 7/20

(52) U.S. Cl. 455/444

(57) ABSTRACT

A method of operating a cellular communications system comprising at least one macro cell having a macro cell base station and at least one micro cell having a micro cell base station, at least part of the micro cell being located within an area served by the macro cell base station, which method comprises the steps of: (I) receiving an electronic indication representative of the quality of service at one or more cellular communications devices served by the macro cell base station; (2) electronically processing the or each electronic indication to obtain a comparison with a predetermined threshold for said quality of service; and (3) electronically controlling signals emitted from the micro cell base station in response to said comparison such that the quality of service of any cellular communication device(s) served by the macro cell base station that are within a predetermined range of the micro cell base station exceeds said predetermined threshold so as to permit the transmission and reception of data in the micro and macro cells on substantially the same frequency band(s).

### FIELD OF THE INVENTION

The present invention relates to a method of operating a cellular communications system, computer operable control means for use in such a system, a base station controller comprising the computer operable control means, a computer readable storage medium storing computer executable instructions for operating the method, a computer program for carrying out the method and parts thereof, and a communications system comprising components as aforesaid operable in accordance with the method.

### BACKGROUND TO THE INVENTION

Often in the traditional cellular structure of wireless communications systems one large cell would often have to cope with a wide variety of traffic demands. For example, some areas of the cell may be relatively sparse in terms of users, whereas other areas have relatively dense distribution of users. The densely populated areas often make higher demands on the capacity of the system than the sparsely distributed areas. Such dense areas have become known in the art as “hot spots” and may be found for example in business districts, airports, stadiums, shopping malls, conference centres etc. To provide the necessary capacity in these hot spots a mixed cell structure has been proposed in which a macro cell provides a large coverage area (typically of the order of several kilometres in radius) within which micro cells (typically of the order of several hundred metres in radius) are located in hot spots to provide increased capacity. This structure has become known in the art as a “hierarchical cell structure” (HCS). The common method of radio resource management in an HCS is by frequency splitting in which the macro cell operates in one frequency band and the micro cell operates in another frequency band, thus creating two “layers”.

One disadvantage of a two (or more) layer HCS with two separated frequency bands, is that spectral efficiency in terms of transmitted bits/km²/frequency band, is higher for micro cells than for macro cells. This problem is particularly acute in wide band code division multiple access (W-CDMA) schemes, where allocation of a large frequency band to macro cells dramatically decreases the total spectral efficiency of the HCS. The layering method also results in a lack of flexibility in resource management. It is very often that the micro cell will run at or near capacity (in bits/s/Hz) most of the time, whereas the macro cell layer often has spare capacity for much of the time. This unused capacity is inefficient radio resource management, which with increasing user numbers demanding higher data rates, is unacceptable.

Thus it is apparent that there is a need for an improvement in the way the available radio resource is used in a HCS or similar architecture.

Code Division Multiple Access (CDMA) schemes offer the possibility of universal frequency re-use since each user is assigned a unique code with which to extract their data from a signal in which data for all users is transmitted. Such coding will be widely used in third generation (“3G”) and future generations (e.g. UMTS) of telecommunication schemes. However, CDMA schemes are normally interference limited since all users transmit simultaneously over the same frequency band. If a CDMA scheme is to be used in an HCS the interference problem must be dealt with if an acceptable or improved quality of service is to be offered.

### SUMMARY OF THE PRESENT INVENTION

Preferred embodiments of the present invention are based on the insight that, in access schemes (for example CDMA, both narrow band and wide band) where it is possible to serve a number of users on the same frequency band, the dynamic inference level from the perspective of the micro cell offers the possibility, with appropriate control of signals (for example power) from the micro cell base station, that all users in the macro and micro cells can be served on the same frequency band(s). In a time division duplex scenario all users may be served on the same frequency band. In a frequency division duplex scenario all users may be served in the same uplink and downlink frequency bands. It is expected that users assigned to the macro cell will be fast moving with low data rates for basic voice services, whereas users assigned to the micro cell will be slower moving with high data rates. The method of the invention serves users assigned to the micro cell when appropriate whilst substantially maintaining the quality of service of the users assigned to the macro cell at substantially all times. By utilising the ability to delay packet switched data for the users in the micro cell, the service of circuit switched users in the macro cell can be prioritised whilst serving all users in the same frequency band(s). Further techniques are applied to optimise quality of service for both groups of users.

According to the present invention there is provided a method of operating a cellular communications system comprising at least one macro cell having a macro cell base station and at least one micro cell having a micro cell base station, at least part of the micro cell being located within an area served by the macro cell base station, which method comprises the steps of.

(1) receiving an electronic indication representative of the quality of service at one or more cellular communications devices served by the macro cell base station;

(2) electronically processing the or each electronic indication to obtain a comparison with a predetermined threshold for said quality of service; and

(3) electronically controlling signals emitted from the micro cell base station in response to said comparison such that the quality of service of any cellular communication device(s) served by the macro cell base station that are within a predetermined range of the micro cell base station exceeds said predetermined threshold so as to permit the transmission and reception of data in the micro and macro cells on substantially the same frequency band(s). In this way interference can be controlled, whilst better use is made of the available radio resource as the micro cell base station can use frequency band(s) that would otherwise be reserved for the macro cell. At least part of the micro cell base station being located within an area served by the macro cell base station includes micro cell base stations that produce interference at the cellular communications device served by the macro cell base station, but whose designated area of coverage may not necessarily overlap the designated area of coverage of the macro cell. This results of course from the fact that electromagnetic signals travelling in free space do not simply cease at a point.

The predetermined range may be substantially fixed (e.g. determined manually by the network operator), or calculated dynamically, for example periodically or substantially continuously. Whether or not a cellular communications device served by the macro cell is within the predetermined range may be decided by ascertaining its position, for example by radiolocation, or by other means such as inferring distance from the micro cell base station from the signal to interference plus noise ratio (SINR). The controlling of signals in step (3) may be by controlling the power for example.

Further features are set out in the appended claims to which attention is hereby directed.

### BRIEF DESCRIPTION OF THE DRAWINGS

In order to provide a more detailed explanation-of how the invention may be carried out in practice, a preferred embodiment relating to use in a cellular communications system will now be described, by way of example only, with reference to the accompanying drawings, in which:

FIG. 1. is a schematic view of a cellular communications system showing an example of downlink interference at a macro cell mobile station caused by a micro cell base station;

FIG. 2 is a schematic view of a cellular communications system showing an example of uplink interference at a macro cell base station caused by a micro cell mobile terminal;

FIG. 3 is a schematic view of a cellular communications system showing an example of downlink interference at a micro cell mobile station caused by a macro cell base station;

FIG. 4 is a schematic view of a cellular communications system showing an example of uplink interference at a micro cell base station caused by a macro cell mobile station;

FIG. 5 is a schematic view of cellular communications system showing an example of downlink interference at the micro cell base station caused by the macro cell base station, and uplink interference at the micro cell mobile station caused by a macro cell mobile station, in time division duplex (TDD) mode, when uplinks or down links are asynchronous, or in frequency division duplex (FDD) mode, when uplink and down link are not perfectly separated;

FIG. 6. is a schematic view of a cellular communications system showing a micro cell base station and its surrounding sensitive area;

FIG. 7 is a flow chart of the stages of operation of a micro cell power control routine in accordance with the present invention;

FIG. 8 is a schematic drawing of a the transfer of world-wide web (WWW) traffic through the protocol layers of a backbone server, micro cell base station and micro cell mobile station;

FIG. 9 is a schematic drawing of data being buffered in the memory of a micro cell base station controller;

FIG. 10 is a schematic illustration of the scheduling and link adaptation process performed by a micro cell base station;

FIG. 11 is a flowchart showing the stages of operation of a rate allocation algorithm in accordance with the present invention;

FIG. 12 is a perspective view of a cellular communications system computer simulation operated in accordance with the present invention;

FIG. 13 is a graph of interference against time (number of iterations) for different numbers of sectors at a central macro cell base station in a computer simulation in accordance with the present invention;

FIG. 14 is a graph of IP packet delay against number of WWW links at a micro cell base station; and

FIG. 15 is a schematic view of a cellular communications system operating in accordance with the present invention.

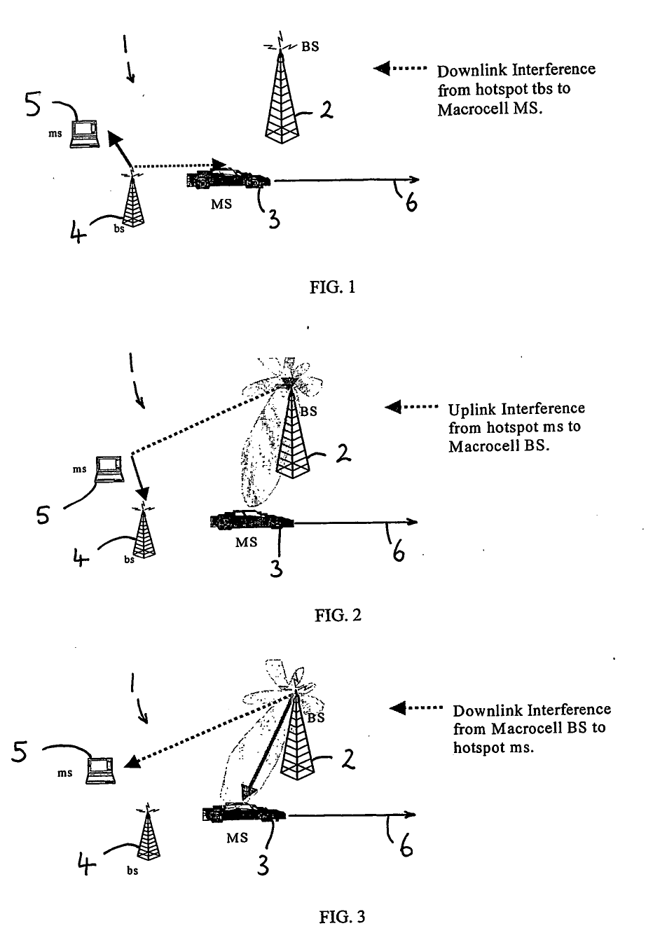

FIGS. 1 to 5 show the various types of interference generated in a hierarchical cell structure using frequency division duplex. These are described in more detail below:

(1) Interference at Macro Cell Mobile Station Caused by Micro Cell Downlink

Referring to FIG. 1 a cellular communication system is generally identified by reference numeral 1 that comprises a macro cell base station 2 covering a large area (for example radius 2-3 km) in which a user or users, for example macro cell mobile station 3 (hereinafter “MS”) can be served. The MS 3 tends to be mobile and requires real-time data services whilst moving, for example voice. A micro cell base station 4 is located within the macro cell and covers a smaller area (for example 100-300 m) where a user or users, for example micro cell mobile station 5 (hereinafter “ms”) can be served. The ms 5 tends to be relatively stationary and requires non real-time data services, for example WWW access and e-mail. Data for both MS 3 and ms 5 is encoded using a CDMA based scheme (either wide-band or narrow band) at base stations 2 and 4 respectively. It is transmitted using adaptive antennae that permit directional control over transmission and reception. 3G and future generation base stations will most likely utilise “smart” antennae (incorporating both adaptive and switched antennae) having high directional capability (down to approximately 15°) for both transmission and reception. Appropriate antennae and methods of operation can be found in, for example, J. C. Liberti, J R. and T. S. Rappaport, “Smart Antennas for Wireless Communications: IS-95 and Third Generation CDMA Applications”, Prentice Hall, 1999.

As shown by the arrow 6 the MS 3 is moving through and past the area served by the micro cell base station 4. The micro cell base station 4 is transmitting data to the ms 5 and the macro cell base station 2 is transmitting data to the MS 3. Since both base stations use one downlink frequency band, the micro cell base station 4 interferes with the signal from the macro cell base station 2, reducing the signal to interference plus noise ratio (SINR) of MS 3 as it passes by.

(2) Interference at Macro Cell Base Station Caused by ms Uplink

As shown in FIG. 2, if the ms 5 is too close (i.e. within a radius of approximately 100 m) to the macro cell base station 2, its uplink signal will cause interference at the macro cell base station 2 and reduce the SINR of the uplink from the MS 3.

(3) Interference at ms Caused by Macro Cell Downlink

As shown in FIG. 3, as the MS 3 passes through the area served by the micro cell base station 4, the downlink frequency from the macro cell base station 2 causes interference at the ms 5, reducing its SINR. Since the power of the macro cell base station 2 is usually higher than the power of the micro cell base station 4 this interference is often severe and limits the data transfer rate on the downlink from the micro cell base station 4 to the ms 5.

(4) Interference at Micro Cell Base Station Caused by MS Uplink

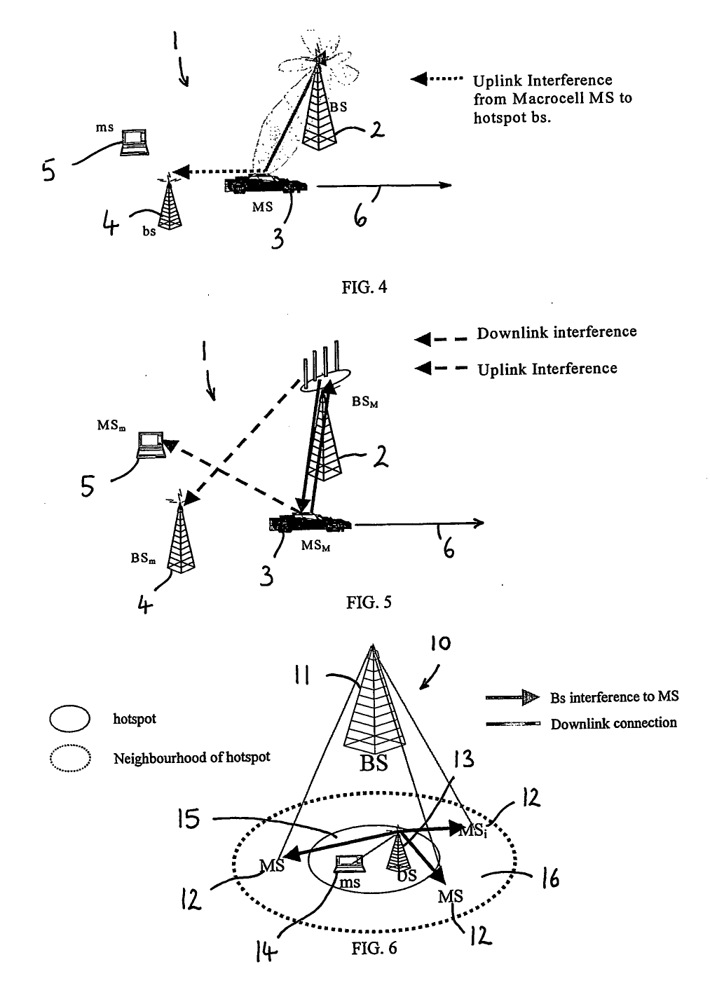

As shown in FIG. 4, as the MS 3 passes through the area served by the micro cell base station 4, its uplink frequency causes interference at the micro cell base station 4. This interference is not usually too problematical due to the asymmetric nature of the data transfer between the micro cell base station 4 and the ms 5 (i.e. often much more data is sent on downlinks than is sent on the uplinks—users tend to require a higher average download data rate than the average upload data rate).

(5) Interference at Micro Cell Base Station Caused by Macro Cell Base Station and Interference at ms Caused by MS

This interference scenario arises in a time division duplex arrangement where the uplinks of the two base stations are not synchronised, as might be the case with asymmetric data traffic flow. If the two mobile stations are close enough then their signals will interfere with one another, reducing the SINR for both. Similarly, the signals from the two base stations will interfere with one another.

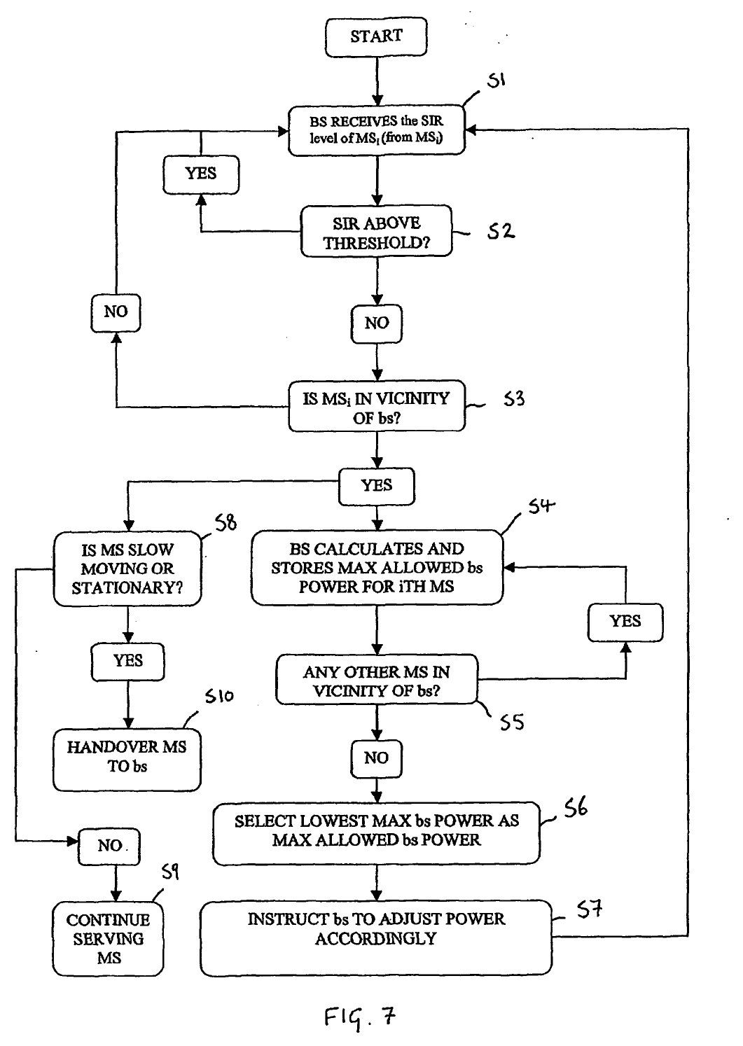

Referring to FIG. 6 part of a cellular communication system is generally identified by reference numeral 10 that comprises a macro cell base station 11, controlled by a base station controller (not shown), that serves a number of macro cell mobile stations 12, in this case mobile telephones. The base station controller may be a suitably programmed computer or network of computers, and may be part of the macro cell base station 11 or remote from it. It will be noted that the base station utilises “beams” (not shown—see FIGS. 2, 3 and 4) that can be formed with an adaptive antenna array to send and receive data to and from the MS. This has a number of beneficial effects in an HCS system. For example, using beams means that power is transmitted over a smaller area to obtain the same SINR, reducing interference in the surrounding area As mentioned above the use of adaptive antenna arrays is common in third and future generation mobile telecommunications networks.

A micro cell base station 13 is located within the area served by the macro cell base station 11 and serves micro cell mobile stations such as ms 14. In accordance with the invention the macro cell and micro cell use the same frequency band thereby making better use of the available radio resource. The micro cell base station 13 primarily serves an area 15, although the actual range of signals emitted from the base station 13 is greater. Thus, a “sensitive area” 16 can be defined around the micro cell base station 13 within which MS 12 experience appreciable interference created by the downlink from the micro cell base station 13 to the ms 14. Of course, the micro cell base station 13 does not actually have to be located within the designated area of coverage of the macro cell base station 11 in order for its sensitive area to affect MS served by the macro cell base station 11. How the sensitive area is determined will be described in more detail below.

During use each of the MS 12 periodically reports back to the macro cell base station 11 every time slot (i.e. approximately every 10/15 ms) with its current actual SINR. If the MS 12 moves into the sensitive area 16 it is very likely that its SINR will drop. Referring to FIG. 7 the stages of operation of the power control algorithm in the micro cell base station controller are shown. At stage S1 the base station 11 receives a SINR from a MS 12 and at stage S2 this is electronically checked against a threshold value for that MS, in this case 6 dB. The threshold value depends on the MS 12 service type as well as coding and physical layer issues, and thus may vary from MS to MS. However, for a given MS service and given coding scheme the threshold value does not vary. The SINR threshold value is determined from link layer simulations. In link layer simulation, the bit error rate (BER) is given as a function of

SINR. For each specific service, there is a specific BER threshold, for example, voice data is 10⁻³ (see Jaana Laiho, Achim Wacker and Tomá\check{s} Novosad, Radio Network Planning and Optimisation for UMTS, WILEY, ISBN: 0-47148653-1, November 2001); with convolutional coding approximately 3.4 dB SINR is required for to obtain 10⁻³ BER. If the SINR is above the threshold value, the routine returns to step S1 and the next SINR for another MS is processed. If the first SINR is below the threshold, the routine proceeds to step S3 where the macro cell base station determines whether or not the MS from which the SINR was received is within the sensitive area 16 of the micro cell base station 13.

The first stage of this part of the algorithm is to determine the actual geographic position of the MS. This is done using a radiolocation method, of which there are several types that could be used. Such methods can be based on measurement of signal strength at the micro cell base station 13; measurement of the angle of arrival of signals from the MS at several base stations using antenna arrays; measurement of the time of arrival of signals from the MS at several base stations; and hybrid angle of arrival and time of arrival methods. Useful discussion of the background to suitable radiolocation methods for determining the position of the MS can be found inter alia in: “Subscriber Location in CDMA Cellular Networks”, Caffery, J. J., Jr. and Stuber, G. L., IEEE Transactions on Vehicular Technology, Volume 47, Issue 2, May 1998, pages 406-416; and “Overview of Radiolocation in CDMA Cellular Systems”, Caffery, J. J., Jr., Communications Magazine, IEEE, Volume 36, Issue 4, April 1998, pages 38-45. Some of these methods can determine the geographical position of the MS to within a circle of radius 100 m; more recent studies have accuracies of less than 50 m. Ideally, although not essentially, any of these methods having accuracy of approximately 10% or less of the radius of the sensitive area is suitable for use with the present invention.

The second stage is to ascertain the radius of the sensitive area, which is determined as follows: for a typical MS near the hot spot base station, the SINR is given by:

$$SINR = \frac{{P}_{MAC} / {L}_{MAC}}{{I}_{MAC} + {P}_{MIC} / {L}_{MIC} + {N}_{0}} \qquad ( 1 )$$

where P_{MAC} and P_{MIC} are the transmitted power from the macro cell base station 11 and micro cell base station 13 respectively, L_{MAC} and L_{MIC} are the path loss from the macro cell and micro cell base stations respectively, I_{MAC} is the interference generated in the macro cell layer and N₀ is noise. Considering the MS at different distances from the micro cell base station, the edge of the sensitive area is defined as that point at which interference from the micro cell is negligible in comparison with interference from the macro cell layer i.e P_{MIC}/L_{MIC}<<I_{MAC}. In practice a 10 dB minimum difference between I_{MAC} and P_{MIC}/L_{MIC} is sufficient for this criteria. In general, assuming that path loss (in dB) is a function of distance D (in km), then the maximum radius Dₘₐₓ of the sensitive area can be obtained from:
P_{MIC}−f(Dₘₐₓ)=I_{MAC}−10

For example, for the Okamura-Hata path loss model (see for example Jaana Laiho, Achim Wacker and Tomá\check{s} Novosad , Radio Network Planning and Optimisation for UMTS, WILEY, ISBN: 0471-48653-1, November 2001) and assuming P_{MIC}^{MAX}=27 dBm and P_{MAC}^{MAX}=40 dBm at 500 m from the micro cell base station, then P_{MIC}/L_{MIC}<−100 dBm (27 dBm−127 dBm=−100 dBm) that is negligible in comparison to I_{MAC}>−85 dBm (40 dBm−125 dBm=−85 dBm). So at this distance the interference at the MS is primarily due to the macro cell layer. This radius depends on the level of macro cell interference around the micro cell base station and the path loss profile in both the macro cell and micro cell. A typical value for this radius is 600 m. In this way it is the size of sensitive area is determined dynamically and is dependent on the micro cell transmission power, such that changes in network topology (e.g. movement of users, changes in the built environment etc.) can be accommodated without input from the network operator. Accordingly, assuming all other parameters remain constant, adjustment of the micro cell transmission power will result in a corresponding change in the radius of the sensitive area

The radiolocation of the MS will enable the position of the MS in relation to the micro cell base station 13 to be determined. This position could be in the form of “straight line” distance measurement between the base station 13 and the MS, such that the MS can be envisaged lying on a circle of radius equal to its distance from the base station 13. This will allow easy comparison with the radius of the sensitive area around the base station. Once the position of the MS relative to the micro cell base station and the size of the sensitive area is known, determining whether or not it is in the sensitive area can be done by a simple comparison of the two values.

If the MS is not in the sensitive area 16, the routine returns to step S1 and the next SINR for another MS is electronically processed. In this case, the base station 11 may use alternative methods for improving the SINR of the MS in question by increasing the transmission power or using beamforming for example.

However, if the MS is in the sensitive area 16 then the base station controller electronically calculates at step S4 the maximum micro cell base station power allowable that would not reduce the SINR of the MS below the 6 dB threshold. This can be done as follows. From equation (1) above, and assuming that the MS is in the sensitive area of only one micro cell (which is usually the case as micro cells are usually spaced a minimum distance from one another), the maximum allowable micro cell base station power P_{MIC}^{MAX} that corresponds to the minimum tolerable SINR for the MS is:

$${SINR}_{MIN} = \frac{{P}_{MAC} / {L}_{MAC}}{{I}_{MAC} + {P}_{MIC}^{MAX} / {L}_{MIC} + {N}_{0}} \qquad ( 2 )$$

From equations (1) and (2) it is possible to express P_{MIC}^{MAX} as

$${P}_{MIC}^{MAX} = {P}_{MAC} \cdot \frac{{L}_{MAC}}{{L}_{MIC}} [ \frac{1}{{SINR}_{MIN}} - \frac{1}{{SINR}_{0}} ] \qquad ( 3 )$$

where SINR₀ is the signal to interference plus noise ratio of a MS assuming there is no micro cell base station interference; SINR₀ is given by

$${SINR}_{0} = \frac{{P}_{MAC} / {L}_{MAC}}{{I}_{MAC} + {N}_{0}}$$

SINR₀ is a value based on a path loss model (see above) and may be determined by the base station controller for each MS. From equation (3) above, it will be apparent that if SINR₀ is less than SINR_{MIN} required by a particular MS, P_{MIC}^{MAX} should not be calculated for that MS as the MS is receiving such a poor quality of service just considering interference from the macro cell layer, that no adjustment of the transmission power of the micro cell base station 13 will improve the quality of service of that MS. For this particular example SINR_{MIN} is 6 dB. So providing SINR₀ is greater than 6 dB for that MS, P_{MIC}^{MAX} should be determined. The base station controller simply ignores any MS for which SINR₀ is less than SINR_{MIN} as it is likely to be dropped any way. Alternatively, the macro cell base station 11 may instruct the micro cell base station 13 to takeover service of the MS, details of which are given below.

Assuming SINR₀ is greater than SINR_{MIN}, the base station controller electronically processes these equations with the appropriate values and stores the calculated maximum power allowable for the MS in memory. At step S5 the base station controller determines whether there are any more MS in the sensitive area 16 and if so repeats step S4 to determine the maximum allowable micro cell base station power for that MS, storing the result in the memory. If there are no further MS in the sensitive area 16, the routine proceeds to step S6 where the macro cell base station controller selects the minimum calculated P_{MIC}^{MAX} from the values stored in the memory and instructs the micro cell base station to adjust its maximum transmitting power to this level at step S7. In this way the system ensures that the quality of service (measured in terms of SINR) of the MS with the worst SINR is not affected by the micro cell base station 13 to a degree that would cause its SINR to fall below the threshold. Since the remaining MS can tolerate a higher power level from the micro cell base station 13 their respective SINRs will not be reduced below the threshold. After step S7 the routine returns to step S1 and the process is repeated, ensuring that the micro cell base station power is continually adjusted for the MS in the sensitive area 16 to ensure that the quality of service (of MSs) is not diminished. The continual adjustment is particularly important as the MS are often moving at speed, for example a mobile telephone in a car, and may be moving nearer and nearer to the micro cell base station 13. This would mean that for a given micro cell base station power the SINR for that MS would continually worsen; in order to mitigate this effect the power of the micro cell base station would be gradually reduced in an attempt to preserve the quality of service of that MS.

At step S3, if the MS is in the sensitive area 16, the routine also proceeds to step S8, at the same time as step S4, at which the base station controller determines whether the MS is slow moving or stationary in the sensitive are 16. This can be achieved from monitoring the MS location over time, for example, from which an approximate indication of speed can be obtained. The interference generated by the MS in the micro cell can also be timed; if the interference exists for more than a predetermined time (typically more than 1, 2, 3 or 4 seconds for example) then the MS should be handed over to the micro cell base station for service. If the MS is determined to be slow moving or stationary, the base station controller estimates how long the MS will stay within the sensitive area. If the MS is moving this can be readily achieved from the speed, position and size of the sensitive area. If the MS is stationary an estimate of the length of time it will remain stationary can be determined from statistical models that take into account the history of that user (see J. G. Markoulidakis et al., “Mobility Modelling in Third-Generation Mobile Telecommunications systems,” IEEE Personal Communications Magazine, vol. 4, No. 4, 1997, pp. 41-56 for example), or that use a traffic model appropriate for that particular date and time of day. Typically, depending on micro and macro cell load and interference levels, such time thresholds are likely to be between a few micro seconds to a few seconds. If it is determined that it is likely to stay less than a predetermined time the macro cell base station 11 continues to serve the MS at step S9. If it is determined that the MS is likely to stay more than the predetermined time, the base station controller determines whether serving the MS through the micro cell base station 13 will reduce interference. As the macro cell base station 11 knows the transmitted power level and direction to that MS, the macro cell to micro cell interference level can be re-calculated without this power. The reduction should be sufficient to increase the maximum allowable micro cell base station power above its present level (as determined above), or enable the micro cell base station to resume transmission. The exact value will depend on the operating environment and hardware. If the reduction is determined to be sufficient, the macro cell base station 11 instructs the micro cell base station 13 to serve the MS at step S10. The aim of this is twofold. Primarily this to ensure that the quality of service of the MS is not reduced by micro cell interference. The MS often need real-time data e.g. voice whereas data transmission to the ms in the micro cell can be temporarily interrupted because these users often have non real-time data e.g. WWW data. Secondly, by handing over the MS to the micro cell base station 13, data transmission to the ms in the micro cell can be resumed because the micro cell base station 13 can now control the power level of signals to both the MS and the ms. Since the MS is nearer to the micro cell base station than the macro cell base station, the required power level for the MS is lower than that required to obtain the same SINR if the data was transmitted from the macro cell base station. How the data for MS and ms is scheduled from the micro cell base station 13 will be described in greater detail below. If the macro cell base station 11 continues to serve the MS, the micro cell base station 13 must cease or severely reduce data transmission rates in order to ensure that the MS quality of service is not diminished.

If at any time the calculated maximum tolerable micro cell base station power falls below a minimum value (e.g. 0.5 mW) for more than a predetermined time (e.g. 1, 2, 3 or 4 seconds) the MS is automatically handed over to the micro cell base station. This threshold depends on the type of non-real time service, and micro and macro cell load and interference level. Typically the time threshold will be between a few micro seconds to a few seconds. Additionally if SINR₀ is less than SINR_{MIN}, as mentioned above in connection with step S4 of FIG. 7, service of the MS may be handed over from the macro cell base station 11 to the micro cell base station. This may be carried out as described above.

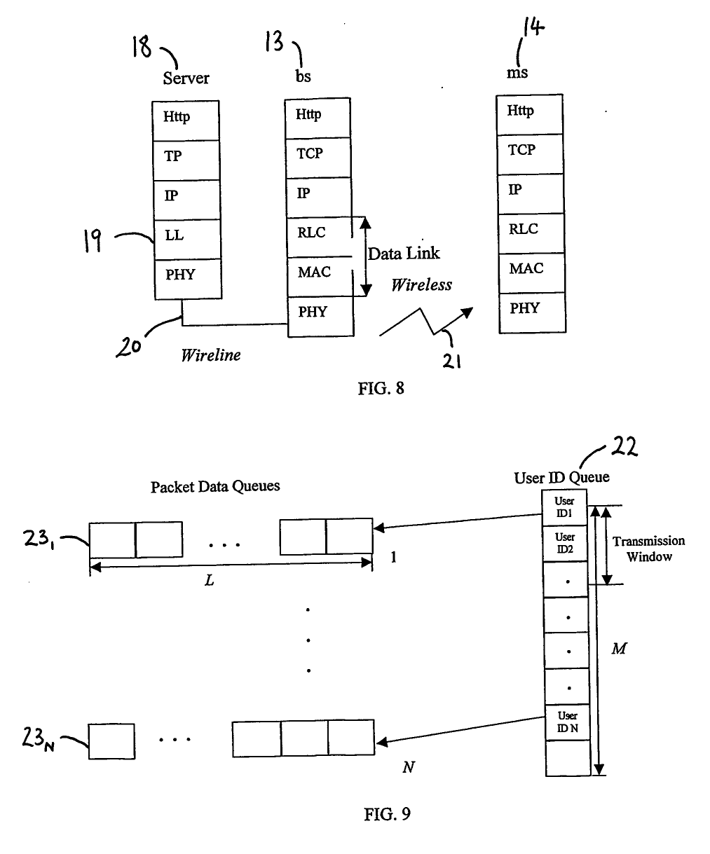

When the micro cell base station 13 takes over service of a MS 12 from the macro cell base station 11, link adaptation and scheduling measures are employed as described below to serve both the MS 12 and the ms 14. As mentioned above, ms 14 served by the micro cell base station 13 tend to be low mobility stations demanding e-mail and WWW data, for example. FIG. 8 shows a backbone server 18 having a stack of protocol layers 19 hypertext transfer protocol “Http”, transfer protocol “TP”, Internet Protocol “IP”, link layer “LL” and physical layer “PHY”) through which WWW data is passed down to a wireline 20, which may be a fibre optic cable for example. The data is passed across the wireline 20 to the micro cell base station 13 where it is converted into a packet train (not shown) in the data link layer (comprising the medium access control “MAC” layer and the radio link control layer “RLC”) of the micro cell base station 13 for onward transmission to the ms 14 over a wireless link 21.

When data for the ms 14 arrives at the micro cell base station 14 a “defer first transmission” mode is employed in which the data for the ms 14 is not immediately relayed on. Instead it is placed in a buffer (not shown) since this kind of data can tolerate delay better than the circuit switched real-time data most frequently demanded by a MS 12. Referring to FIG. 9 the format in which the data is held in the memory buffer is shown. There are two queues maintained: firstly a user ID queue 22 that keeps a record of the current wireless data links between the micro cell base station 13 and the N users served thereby (comprising both MS 12 and ms 14); and secondly, data for each of the N users is stored in N queues 23₁ to 23_{N}, each queue being able to store a maximum of L₁, L₂, . . . L_{N} packets. For example, an IP-based server can store one or a few IP packets (one IP packet size upto 1.5 kbytes). Any MS requiring real-time data via a circuit switched link are placed at the top of the ID queue 22. In this way data demanded by the MS 12 can be prioritised ensuring that its quality of service is not diminished due to the handover, whilst also allowing ms 14 to be served. If a user demands data at a ms 14, that ms sends a request to the micro cell base station 13 to check if the data queue 23_{N} for that user is full or not. If it is full, the user's request will be blocked. When the buffer allocated to the ms 14 in the micro cell base station is completely empty the user's ID will be removed from the ID queue 22. Otherwise the data for that user will be obtained and queued in the buffer for distribution according to the scheduling and link adaptation algorithms described below. Once the data queue for that user is full, overflow occurs.

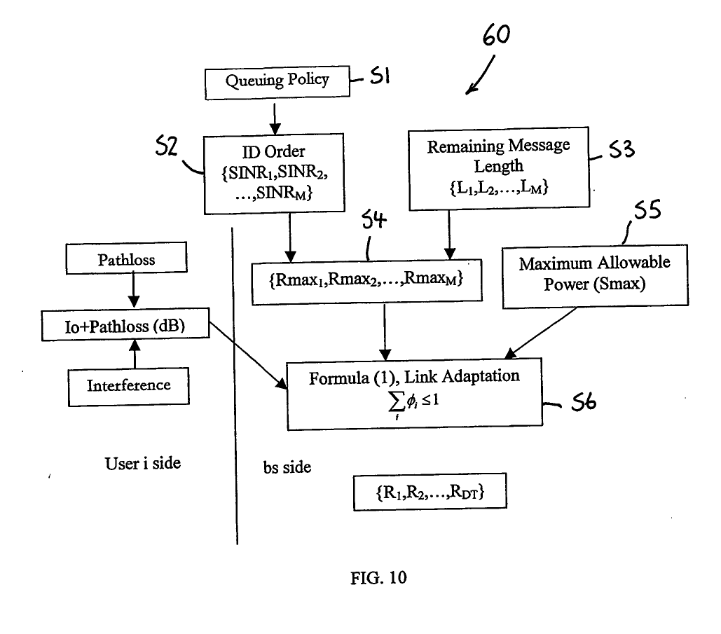

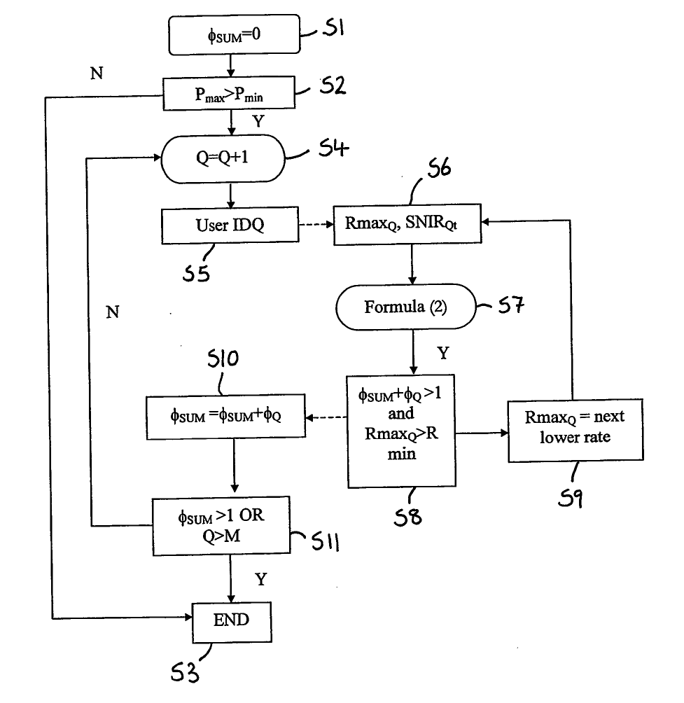

Referring to FIG. 10 a flowchart of the main stages of the scheduling and link adaptation algorithms is generally identified by reference numeral 60. Step S1 represents the queuing policy used in the buffer of that base station, for example first-in-first-out (FIFO), round robin (RR), shortest first out (SFO), interference based queuing (IBQ) etc. At step S2 the ID queue is formed according to the queuing policy; any MS being served by the micro cell base station will be prioritised by being placed in the highest positions in the queue i.e. ID 1, ID 2 etc. The remaining ms are ordered follows. FIFO: the entries in the ID queue are ordered according to the receiving times of users' requests at the base station. If several requests are received at the same frame time, they will be ordered randomly; RR: at the end of each frame, if the user on the top of the ID queue has just transmitted, then in the next frame, the user is moved to the end of the ID queue and the users after it in the queue shift up. If, because of lack of capacity, the user on the top is not permitted to transmit any information during this frame, it will remain at the top until transmission occurs. For newly arrived users, the ordering rule is the same as that in FIFO; SFO: the entries in the ID queue are ordered according to the size of the message remaining in the data users' buffer, smallest first. The entries with the same value of remaining message size are ordered randomly; IBQ: users are ordered according to I_{interlayer}−Pathloss (in dB), where I_{interlayer} is interlayer interference and Pathloss is the user's path loss profile in dB.

There are M members of the queue, each having SINRs designated as SINR₁, SINR₂ . . . SINR_{M}. At step S3 the data for each ID is placed in order, the queue for each ID having length L₁, L₂ . . . L_{M} respectively. At step S4 the maximum data transmission rate for each ID is determined that, in combination with the maximum allowable micro cell base station power at step S5 (as calculated from above), is used at step S6 to determine the actual transmission rate for each ID. The maximum data transmission rate is determined from the number of packets in that user's queue. For example, if the user has two packets queued, the maximum data transmission rate would not be set to three packets per frame.

The scheduling and link adaptation algorithms are designed to maximise the throughput of data for all MS 12 and ms 14 with the priority being to maintain the quality of service for the MS 12. Since CDMA systems are inherently interference limited, the resources of interest are power and data transmission rate. Assuming the Gaussian approximation for multiple access interference (MAI) we can define the fraction of power allocated to user i as:

$${ϕ}_{i} = \frac{{( SINR )}_{i} {R}_{i} ( {I}_{inter} + {I}_{intra} + {I}_{interL} + {N}_{0} )}{β PC} \qquad ( 2 )$$

where the MAI has been decomposed into inter-cell, intra-cell and inter-layer components respectively, and 0≦φᵢ≦1. P is the total output power from the micro cell base station 11, R is the transmission rate, C is the constant chip rate, N₀ is noise, β is the user's path loss factor in real terms (not in dB) and SINRᵢ is the signal to interference plus noise ratio. The link adaptation is based on this equation and is used to adjust the transmission rate for each user to ensure that the target SINR is met.

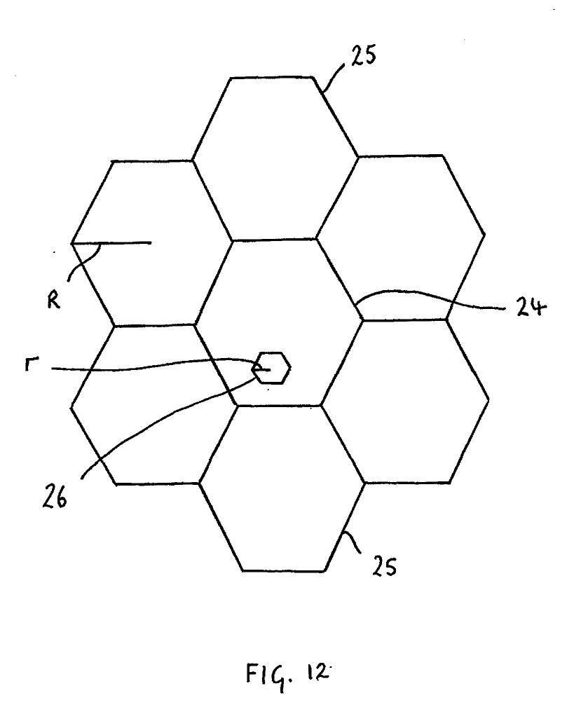

Referring to FIG. 11 the stages of operation of the link adaptation algorithm for determining the allowable data transmission rate for each user in the ID queue is identified by reference numeral 70. An initialising step S1 sets φₛᵤₘ equal to zero in a computer memory (not shown) and Q equal to zero, where Q is used to select an ID from the ID queue at a later step. At step S2 the routine checks whether the maximum micro cell base station power P_{MIC}^{MAX} is greater than the minimum micro cell base station power P_{MIC}^{MIN} required for transmission. If not, the routine is ended at step S3. If it is greater, the routine proceeds to step S4 where Q is set to Q+1 and at step S5 the (Q+1)th ID is selected from the queue, in this case the first ID. At step S6 the maximum allowable data transmission rate RMAX₁ and the signal to interference plus noise ratio at time t SINR₁ₜ is obtained from the micro cell base station controller memory and at step S7 these values input into formula (2) above and electronically processed to obtain φ₁ i.e. the fraction of maximum micro cell base station power that can be allocated to that user with ID 1. At step S8 φ₁ is electronically processed to determine whether φₛᵤₘ+φ₁ is greater than one and whether RMAX₁ is greater than the minimum possible data transmission rate. If either φₛᵤₘ+φ₁ is greater than one or if RMAX₁ is less than the minimum possible data transmission rate then at step S9 RMAX₁ is set at the next lower rate and the routine returns to step S6. This part of the routine is repeated until φₛᵤₘ+φ₁ is less than 1 and RMAX₁ is greater than the minimum possible data transmission rate. If so the routine proceeds to step S10 where φₛᵤₘ is set to φ₁+φ₁. After operating the routine on a number of users this step adds the new allowable fraction of micro cell base station power to the existing fraction. Then at step S11 the new value of φₛᵤₘ is electronically processed to determine whether it is greater than one (i.e. greater than the maximum allowable micro cell base station power) and whether Q is equal to the number of IDs in the queue. Only if both are negative does the routine return to step S4 where now the (Q+1)th ID, i.e. second in this case, will be processed. This routine ensures two things: firstly, by placing MS users at the head of the queue, they will almost certainly be guaranteed to be served by the micro cell base station at all times with the higher data rates; and secondly, when the maximum available micro cell base station power has been allocated the routine ends.

A situation may arise where, for example, the queue has ten IDs of which according to the method described above only four can be served before the maximum micro cell base station power is reached. However, the method ensures that the MS being served by the micro cell base station will always be prioritised for service and that the ms will receive data when the interference scenario permits. Once the routine has finished processing all IDs the routine is re-started at step S1 and the SINRs for each mobile station are processed for time 2t. In this way the micro cell base station continually adjusts the transmission rates and the number of users being served, which is important bearing in mind the mobility of the MS.

The scheduling algorithm used in combination with the link adaptation is algorithm allows optimisation of data traffic performance i.e. MS 12 quality of service is maintained whilst ms 14 still receive data when conditions allow. Effectively the algorithms maintain data transmission to the MS 12 and send data to the ms 14 when conditions permit. However, the operation is subject to the maximum allowable micro-cell base station power that is determined in step S6 in FIG. 7. Essentialy, there are two constraints: (1) the maximum transmission power can be supported by the micro cell base station; and (2) the maximum transmission power is allowed to be transmitted, subject to the bit error rate (BER) requirements of MS in macro-cell. Furthermore, where this method is used in combination with smart antennae that can utilise directional transmission and reception methods, interlayer interference (from macro-cell to hot spot) will be reduced and more micro cells will be able to operate at or near maximum transmission power.

The applicant has simulated the aforementioned method in software. The parameters of the simulation were as follows:

Macro Cell

(1) Cell radius of 2 km;
(2) Uniform distribution of MS 12;
(3) User mobility (based on model in specified in “Universal Mobile Telecommunications System (UMTS): selection procedures for the choice of radio transmission technologies of UMTS (UMTS 30.03 version 3.2.0) TR 101 112 V3.2.0—hereafter “[1]”) with average mobile station speed of 72 km/hr;
(4) Vehicular environment with path loss as in [1] and log-normal shadow fading with 10 dB standard deviation;
(5) Speech service at 12.2 kbps.
   Micro Cell
(1) Cell radius of 150 m;
(2) Uniform distribution of users;
(3) WWW traffic model in [1] with packet inter-arrival rate of 0.5 s;
(4) All micro cell users stationary;
(5) Okamura-Hata path loss model (see Jaana Laiho, Achim Wacker, Tomá\check{s} Novosad, Radio Network Planning and Optimisation for UMTS, ISBN: 0-47148653-1, Cloth, 510 Pages, November 2001).

The model is shown schematically in FIG. 12 in which a central macro cell 24 is surrounded by six macro cells 25, all being of radius R=2 km. A micro cell 26 is located in the central macro cell 24 of radius r=150 m. In use, the micro cell base station controller (not shown) determines the maximum allowable micro cell base station power in accordance with the method described with reference to FIG. 7, taking into account the SINR (or bit error rates) of MS within the sensitive area around the micro cell which is 600 m radius in this example. There are ten MS within the sensitive area The micro cell base station controller then queues the users and adjusts the transmission window size (i.e number of users for whom data can be transmitted) in accordance with the scheduling algorithm above. The link adaptation algorithm determines the data transfer rates to the micro cell mobile stations (as described above) choosing any of 60 kbps, 120 kbps, 240 kbps or 480 kbps (complying with UMTS transport block size (UMTS 30.03 version 3.2.0)) to make

$${\sum }_{i} {ϕ}_{i} \leq 1$$

and by taking into consideration the amount of free memory in the buffer. The simulation did not include a model of the smart antennae that would utilise beam forming in 3G and future generation systems. However, as described below the simulation was run with cells having different numbers of sectors, which is a simple type of beam forming.

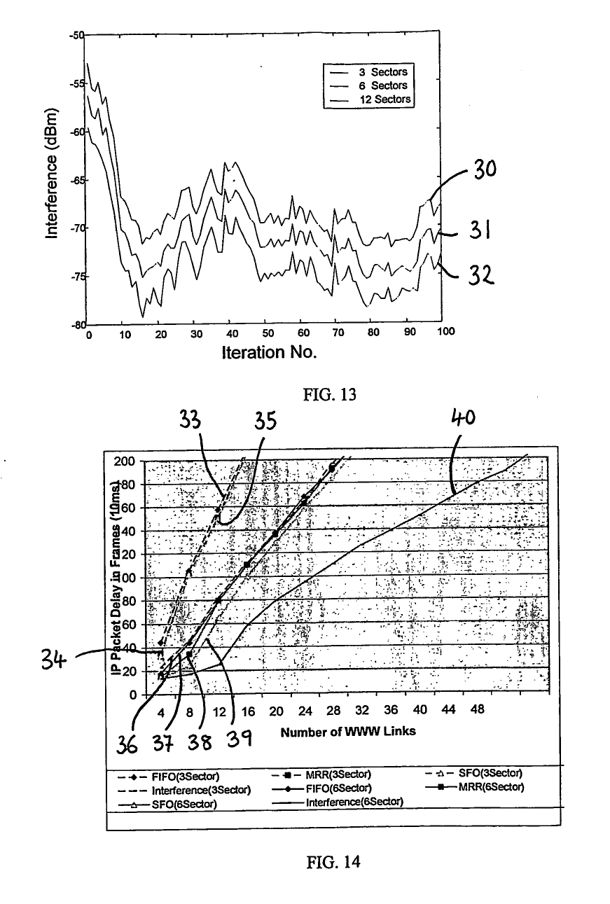

FIG. 13 is a graph of macro cell to micro cell interference level compared to one milliwatt (−0 dBm) against time, for three different numbers of sectors in the central macro cell base station. It is clear that increasing the number of sectors of the central macro cell base station decreases the interference level at the micro cell base station. Trace 30 was obtained when the central macro cell base station had three sectors; trace 31 was obtained when the central macro cell base station had six sectors; and trace 32 was obtained when the central macro cell base station had twelve sectors. Further improvements are expected with smart antennae with directional capacity.

FIG. 14 is a graph of the performance of various queuing schedules at the micro cell base station in terms of packet delay against the number of WWW links supported by the micro cell base station. Curve 33 is a first-in-first-out (FIFO) queuing schedule for three sectors; curve 34 is a round robin (RR) queuing schedule for three sectors; curve 35 is a shortest first out (SFO) queuing schedule for three sectors; curve 36 is an interference based queuing schedule in accordance with the method of the invention for three sectors; curve 37 is a first-in-first-out (FIFO) queuing schedule for six sectors; curve 38 is a round robin (RR) queuing schedule for six sectors; curve 39 is a shortest first out (SFO) queuing schedule for six sectors; curve 40 is an interference queuing schedule in accordance with the method of the invention for six sectors. It is readily apparent that, using the present invention, a larger number of WWW links can be supported with a lower delay at the micro cell base station when a larger number of sectors are defined at the central macro cell base station. Once again further improvement is expected by utilising smart antennae common to 3G and future generation systems.

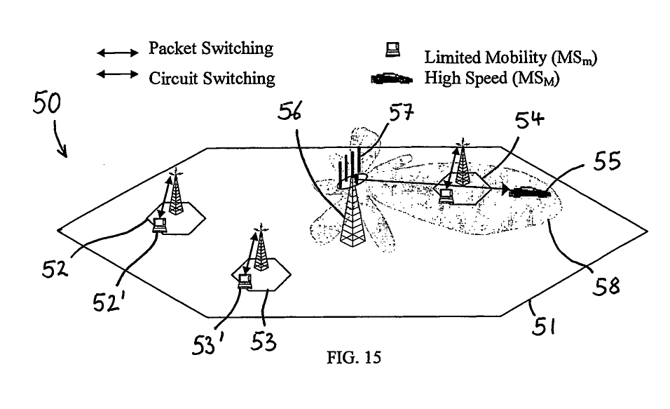

Referring to FIG. 15 a cellular communications system generally identified by reference numeral 50 comprises a macro cell 51 within which are three micro cells 52, 53, and 54 respectively. Each micro cell has a respective base station that serves a respective micro cell mobile station (“ms”) 52′, 53′ and 54′. A macro cell mobile station (“MS”) 55 is served by a macro cell base station 56 that has a smart antenna 57 capable of transmission and reception to and from the MS 55 with a pattern 58 as shown. In use the cellular communications system is operated in accordance with the method described above. As the MS 55 moves through the macro cell the interference generated in the micro cells will vary with time depending on the position of the MS 55. In the position shown the micro cell 54 will have to adjust its power and data transmission rate to ensure that the quality of service of the MS 55 is not impaired. If the MS 55 is stationary for sometime in the sensitive area of the micro cell 54, it may be handed over to the micro cell base station so that transmission can be resumed or continued to ms 54′ in the micro cell 54. When the MS 55 is in the top left corner of the macro cell 51, the use of the adaptive antenna 57 means that all mobile stations can be served in the same frequency band substantially without impairment

The embodiments described above have been described with reference to one or few mobile stations for comprehensibility. In reality, of course, a much larger number of mobile stations will be served by both macro and micro cells.

Algorithms implementing the above methods can be run on appropriate computer hardware (e.g. base station controller) at either the macro cell base station or micro cell base station, or a combination of both. They may be stored on and run from plug-in type memory. In one embodiment macro cell MS calculate the maximum tolerable micro cell base station power and inform the macro cell base station accordingly. This would require a software update of macro cell MS that could be transmitted over the wireless downlink. Alternatively, when implemented at a base station no hardware or software changes are necessary at the mobile stations since regular indications of quality of service are reported back to the base station. Such indicators of quality of service include: SINR, bit error rate and packet delay (which is closely related to blocking and buffer overflow).

The invention is applicable to CDMA schemes or similar using frequency division duplexing or time division duplexing. The invention as described above has assumed an interference limited scenario. If the scenario is code limited case, the spreading codes should be used under a secondary scrambling code in order to provide orthoganility between channels.

An alternative use of the present invention would be to provide movable “hot-spot” base stations that could be installed for temporary use in an area where demand is likely to be high for a short period of time, for example in stadiums, exhibitions, conference centres, shopping centres, airports etc. This hot-spot base station would act as a micro cell under a permanent macro cell in the area. The use of the power control, scheduling and link adaptation methods described above would help to meet the demand in the area without reducing the quality of service of mobile stations being served by the macro cell.

Whilst the method of determining the radius of the sensitive area 16 is performed using a radiolocation method, it will be appreciated that other methods could be used. For example, the network operator could set the radius of the sensitive area manually. Alternatively, those MS within the predetermined distance can be ascertained by comparing electronic signals representative of macro cell interference and micro cell interference at each MS, the predetermined range being that distance at which micro cell interference is negligible in comparison with macro cell interference. The electronic signals can be generated using a path-loss model and knowing the transmission powers of the micro and macro cell base stations. This can provide a theoretical summed SINR due to signals from both the micro cell and macro cell base stations that can be compared to the actual SINR at each MS.

Although the embodiments of the invention described with reference to the drawings comprise computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant methods.

1. A method of operating a CDMA cellular communications system comprising at least one macro cell having a macro cell base station and at least one micro cell having a micro cell base station, at least part of the micro cell being located within an area served by the macro cell base station, separate frequency bands normally required for simultaneous communication of data from said macro cell and micro cell base stations, which method comprises the steps of
(1) receiving an electronic indication representative of the quality of service at one or more cellular communications device served by the macro cell base station;
(2) electronically processing the or each electronic indication to obtain a comparison with a predetermined threshold for said quality of service; and
(3) maintaining said quality of service above said predetermined threshold for any cellular communications device(s) served by the macro cell base station that is within a predetermined range of the micro cell base station by limiting the power of signals transmitted from the micro cell base station, whereby data may be transmitted and received in the micro and macro cells on substantially the same CDMA frequency band(s):

2. A method as claimed in claim 1, wherein those cellular communications device(s) within said predetermined range can be determined by electronically processing signals representative of macro cell interference and micro cell interference at each cellular communications device, the predetermined range being that distance at which micro cell interference is negligible in comparison with macro cell interference.

3. A method as claimed in claim 1, wherein said predetermined range is that distance from the micro cell base station at which micro cell interference is at least approximately 10 dB less than macro cell interference.

4. A method as claimed in claim 1, further comprising the steps of generating an electronic signal representative of said predetermined range, receiving respective electronic signals representative of the distance between said micro cell base station and the or each cellular communications device served by the macro cell, and processing said electronic signals so as to determine those cellular communications devices served by the macro cell that are within said predetermined range.

5. A method as claimed in claim 4, wherein said electronic signals representative of the distance between said micro cell base station and the or each cellular communications device are obtained by the steps of determining respective estimated geographic position of the or each cellular communications device and processing said estimated geographic position to determine a distance between said micro cell base station and the or each cellular communication device.

6. A method as claimed in claim 5, further comprising the step of obtaining said respective estimated geographic position of the or each cellular communications device with a radiolocation method.

7. A method as claimed in claim 1, wherein the step (3) is carried out by electronically determining a tolerable micro cell base station power level for the or each cellular communications device served by the macro cell base station and instructing said micro cell base station to transmit all signals at a power substantially no higher than said tolerable level.

8. A method as claimed in claim 7, further comprising the steps of electronically determining a tolerable micro cell base station power level for all cellular communications devices served by the macro cell base station within said predetermined range, and electronically instructing said micro cell base station to transmit signals at a power substantially no higher than the lowest tolerable micro cell base station power that has been determined for said cellular communications devices.

9. A method as claimed in claim 7, wherein said tolerable micro cell base station power level is a fraction of the power of signals from the macro cell base station.

10. A method as claimed in claim 9, wherein for each cellular communications device said tolerable micro cell base station power is obtainable from:
$${P}_{MIC}^{MAX} = {P}_{MAC} \cdot \frac{{L}_{MAC}}{{L}_{MIC}} [ \frac{1}{{SINR}_{MIN}} - \frac{1}{{SINR}_{0}} ]$$
where P_{MIC}^{MAX} is the maximum tolerable micro cell base station power, P_{MAC} is the transmitted power from the macro cell base station, L_{MAC} and L_{MIC} are the path loss from the macro cell and micro cell base stations respectively, SINR_{MIN} corresponds to the minimum tolerable signal to interference plus noise ratio for each cellular communications device, and SINR₀ is the signal to interference plus noise ratio of the cellular communications device assuming there is no micro cell base station interference.

11. A method as claimed in claim 1, further comprising the step of electronically determining a residence time in said predetermined range for the or each cellular communications device served by the macro cell base station, said residence time being useable to substantially maintain the quality of service of said cellular communications device(s).

12. A method as claimed in claim 1, further comprising the step of substantially ceasing transmission of signals from said micro cell base station to cellular communications device(s) served thereby in order to substantially maintain the quality of service of cellular communications devices served by the macro cell base station that are within said predetermined range.

13. A method as claimed in claim 1, further comprising the step of electronically instructing said micro cell base station to take over service of the or each cellular communications device within said predetermined range, enabling resumption or continuation of transmission and reception of signals to and from cellular communications devices served by the micro cell base station and/or macro cell base station.

14. A method as claimed in claim 1, further comprising the step of prioritizing service from said micro cell base station to cellular communications devices requiring substantially real-time data above those requiring substantially non-real-time data.

15. A method as claimed in claim 1, further comprising the step of serving cellular communications device(s) from said macro cell base station with at least one adaptive antenna capable of directional transmission and/or reception, thereby enabling reduction in the necessary transmission power of said micro cell base station and cellular communications devices served thereby to achieve a given signal quality.

16. A method as claimed in claim 1, further comprising the step of electronically adjusting the data transmission rate to cellular communications devices served by the micro cell base station.

17. A method as claimed in claim 1, further comprising the steps of electronically processing said electronic indication and a selected data transmission rate for each cellular communications device to determine a proportion of the maximum tolerable micro cell base station power for that cellular communications device, until either all of said available micro cell base station power has been assigned or the total number of cellular communications devices been processed, prioritizing assignment of transmission power to cellular communications device(s) requiring substantially real-time data above those requiring substantially non-real time data, and transmitting data to each cellular communications device at the respective assigned transmission power.

18. The method as claimed in claim 17, wherein said proportion for the ith cellular communications device is obtainable from:
$${ϕ}_{i} = \frac{{( SINR )}_{i} {R}_{i} ( {I}_{inter} + {I}_{intra} + {I}_{interL} + {N}_{0} )}{β PC}$$
assuming the Gaussian approximation for multiple access interference, and where SINRᵢ is the signal to interference plus noise ratio, R is the transmission rate from the micro cell base station, Iᵢₙₜₑᵣ, Iᵢₙₜᵣₐ and I_{interL} are inter-cell, intra-cell and inter-layer interference components, respectively, Nₒ is noise, β is the user's path loss factor in real terms (not in dB), P is the total output power from the micro cell base station, C is the constant chip rate and where 0≦φ≦1.

19. The method as claimed in claim 17 or 18, further comprising the step of electronically adjusting said selected data transmission rate if said electronic processing determines said proportion to be such that, on its own or when summed with proportion(s) calculated for any other cellular communications device(s), it exceeds said maximum tolerable micro base station transmission power, and re-performing said electronic calculation with said adjusted selected data rate.

20. A method as claimed in claim 1, further comprising the steps of electronically instructing buffering of data for cellular communications devices served by the micro cell base station, and adjusting the number of those cellular communications devices to which data is transmitted to increase the ability of the system to serve the remaining cellular communications devices being served by the micro cell base station.

21. A computer operable controller for use with a CDMA cellular communications system comprising at least one macro cell having a macro cell base station and at least one micro cell having a micro cell base station, at least part of the micro cell being located within an area served by the macro cell base station, separate frequency bands normally required for simultaneous communication of data from said macro cell and micro cell base stations, the computer operable controller comprising:
a receiver for receiving an electronic indication representative of the quality of service at one or more cellular communications devices served by the macro cell base station; and
a processor for electronically processing the or each electronic indication to obtain a comparison with a predetermined threshold for said quality of service;
whereby said computer operable controller can maintain said quality of service above said predetermined threshold for any cellular communication device(s) served by the macro cell base station that is within a predetermined range of the micro cell base station by limiting the power of signals transmitted from the micro cell base station, whereby data may be the transmitted and received in the micro and macro cells on substantially the same CDMA frequency bands.

22. A computer operable controller as claimed in claim 21, said processor for determining those cellular communications device(s) within said predetermined range y electronically processing signals representative of macro cell interference and micro cell interference at said cellular communications device(s), the predetermined range being that distance at which micro cell interference is negligible in comparison with macro cell interference.

23. A computer operable controller as claimed in claim 22, wherein said predetermined range is that distance from the micro cell base station at which micro cell interference is at least approximately 10 dB less than macro cell interference.

24. A computer operable controller as claimed in claim 21, further comprising a generator for generating respective electronic signals representative of the distance between said micro cell base station and the or each cellular communications device served by the macro cell, said processor for processing said electronic signals so as to determine those cellular communications devices served by the macro cell that are within said predetermined range.

25. Computer operable control means A computer operable controller as claimed in claim 24, wherein said generator means for generating electronic signals representative of the distance between said micro cell base station and the or each cellular communication can receive an electronic signal representative of a respective estimated geographic position of the or each cellular communications device and can process said signal to determine a distance between said micro cell base station and the or each cellular communication device.

26. A computer operable controller as claimed in claim 25, further comprising a position estimator means for obtaining said respective estimated geographic position of the or each cellular communications device by a radiolocation method.

27. A computer operable controller as claimed in claim 21, further comprising said processor for determining a tolerable micro cell base station power level for the or each cellular communications device served by the macro cell base station and means for instructing said micro cell base station to transmit all signals at a power substantially no higher than said tolerable level.

28. A computer operable controller as claimed in claim 27, further comprising said processor for determining a tolerable micro cell base station power level for all cellular communications devices served by the macro cell base station within said predetermined range, whereby said computer operable controller instructs said micro cell base station to transmit signals at a power substantially no higher than the lowest tolerable micro cell base station power that has been determined for said cellular communications devices.

29. A computer operable controller as claimed in claim 27, wherein said processor can, in use, determine said tolerable micro cell base station power as a fraction of the power of signals from the macro cell base station.

30. A computer operable controller as claimed in claim 29, wherein for each cellular communications device said tolerable micro cell base station power is obtainable from:
$${P}_{MIC}^{MAX} = {P}_{MAC} \cdot \frac{{L}_{MAC}}{{L}_{MIC}} [ \frac{1}{{SINR}_{MIN}} - \frac{1}{{SINR}_{0}} ]$$
where P_{MIC}^{MAX} is the maximum tolerable micro cell base station power, P_{MAC} is the transmitted power from the macro cell base station, L_{MAC} and L_{MIC} are the path loss from the macro cell and micro cell base stations respectively, SINR_{MIN} corresponds to the minimum tolerable signal to interference plus noise ratio for each cellular communications device, and SINR₀ is the signal to interference plus noise ratio of the cellular communications device assuming there is no micro cell base station interference.

31. A computer operable controller as claimed in claims 21, further comprising said processor for determining a residence time in said predetermined range for the or each cellular communications device served by the macro cell base station, said residence time being useable to substantially maintain the quality of service of said cellular communications device(s).

32. A computer operable controller as claimed in claim 21, further comprising said processor for ceasing transmission of signals from said micro cell base station to cellular communications device(s) served thereby to substantially maintain the quality of service of cellular communications devices served by the macro cell base station and/or micro cell base station.

33. A computer operable controller as claimed in claim 32, further comprising said processor for instructing said micro cell base station to take over service of the or each cellular communications device within said predetermined range, enabling resumption or continuation of transmission and reception of signals to and from cellular communications devices served by the micro cell base station.

34. A computer operable controller as claimed in claim 21, further comprising said processor for prioritizing service from said micro cell base station to cellular communications devices requiring substantially real-time data above those requiring substantially non-real-time data.

35. A computer operable controller as claimed in claims 31, further comprising a controller for controlling at least one adaptive antenna capable of directional transmission and/or reception, thereby enabling reduction in the necessary transmission power of said micro cell base station and cellular communications devices served thereby to achieve a given signal quality.

36. A computer operable controller as claimed in claim 21, further comprising said processor for adjusting the data transmission rate to cellular communication devices served by the micro cell base station.

37. A computer operable controller as claimed in claim 36, further comprising said processor for
(a) electronically processing said electronic indication and a selected data transmission rate for each cellular communications device to determine a proportion of the maximum tolerable micro cell base station power for that cellular communications device, until either all of said available micro cell base station power has been assigned or the total number of cellular communications devices been processed,
(b) for prioritizing assignment of transmission power to cellular communications device(s) requiring substantially real-time data above those requiring substantially non-real-time data, and
(c) for instructing transmission of data to each cellular communications device at the respective assigned transmission power.

38. A computer operable controller as claimed in claim 37, wherein said proportion for the ith cellular communications device is obtainable from:
$${ϕ}_{i} = \frac{{( SINR )}_{i} {R}_{i} ( {I}_{inter} + {I}_{intra} + {I}_{interL} + {N}_{0} )}{β PC}$$
assuming the Gaussian approximation for multiple access interference, and where SINRᵢ is the signal to interference plus noise ratio, R is the transmission rate from the micro cell base station, Iᵢₙₜₑᵣ, Iᵢₙₜᵣₐ and I_{interL} are inter-cell, intra-cell and inter-layer interference components respectively, Nₒ is noise, β is the user's path loss factor in real terms (not in dB), P is the total output power from the micro cell base station, C is the constant chip rate and where 0≦φ≦1.

39. A computer operable controller as claimed in claim 37, further comprising said processor for electronically adjusting said selected data transmission rate if said processor determines said proportion to be such that, on its own or when summed with proportion(s) calculated for any other cellular communications device(s), it exceeds said maximum tolerable micro base station transmission power, and means for re-performing said electronic calculation with said adjusted data rate.

40. A computer operable controller as claimed in claim 21, further comprising a buffer for buffering data for cellular communications devices served by the micro cell base station, said processor for adjusting the number of those cellular communications devices to which data is transmitted to increase the ability of the system to serve the remaining cellular communications devices being served by the micro cell base station.

41. A base station controller comprising a computer operable controller-as claimed in claims 21.

42. A computer readable medium storing computer executable instructions for carrying out a method according to claim 1.

43. A computer program comprising program instructions for causing a computer, such as a base station controller, to carry out the method of claim 1.

44. A computer program comprising program instructions for causing a computer, such as a macro cell base station controller, to perform the method steps of claim 1.

45. A computer program comprising program instructions for causing a computer, such as a micro cell base station controller, to perform the method steps of claim 11.

46. A CDMA communications system comprising a computer operable controller as claimed in claim 21, at least one macro cell base station, and at least one micro cell base station having at least a part of the micro cell within the area served by said macro cell base station.

47. A method of operating a cellular communications system comprising at least one macro cell having a macro cell base station and at least one micro cell having a micro cell base station, at least part of the micro cell being located within an area served by the macro cell base station, which method comprises the steps of prioritizing transmission of data to a first group of cellular communications devices served by the micro cell base station that require substantially real-time data above a second group of cellular communications devices that require substantially non-real-time data, by assigning a fraction of available micro cell base station power to each cellular communications device based on the signal to interference plus noise ratio of each device, starting with those in said first group, either until all of said available micro cell base station power is assigned or until all of said cellular communication devices have been assigned a fraction; and transmitting data to said first and/or second groups of cellular communications devices based on said fractions.

48. A system as claimed in claim 46, wherein said fraction for the ith cellular communications device is obtainable from:
$${ϕ}_{i} = \frac{{( SIN R )}_{i} {R}_{i} ( {I}_{inter} + {I}_{intra} + {I}_{interL} + {N}_{0} )}{β PC}$$
assuming the Gaussian approximation for multiple access interference, and where SINRᵢ is the signal to interference plus noise ratio, R is the transmission rate from the micro cell base station, Iᵢₙₜₑᵣ, Iᵢₙₜᵣₐ and I_{interL} are inter-cell, intra-cell and inter-layer interference components respectively, No is noise, β is the user's path loss factor in real terms (not in dB), P is the total output power from the micro cell base station, C is the constant chip rate and where 0≦φ≦1.
